(19) United States
(12) Patent Application Publication
(10) Pub. No.: US 2007/0234300 A1
(43) Pub. Date: Oct. 4, 2007

(54) Method and Apparatus for Performing State-Table Driven Regression Testing

(76) Inventors: David W. Leake, Peoria, AZ (US); Thomas W. Crosley, Gilbert, AZ (US); John Daniel Henderson, Chandler, AZ (US)

Correspondence Address: GLENN PATENT GROUP, 3475 EDISON WAY, SUITE L, MENLO PARK, CA, 94025, US

(21) Appl. No.: 11/551,672

(22) Filed: Oct. 20, 2006

Related U.S. Application Data
(63) Continuation-in-part of application No. 10/472,856, filed on Sep. 18, 2003, now Pat. No. 7,133,710.
(60) Provisional application No. 60/735,970, filed on Nov. 9, 2005.

(51) Int. Cl. G06F 9/44

(52) U.S. Cl. 717/124

(57) ABSTRACT

The invention relates to a method and apparatus for performing state-table driven regression testing. More particularly, the invention relates to an application wherein a release build is used without the use of a debug build, which ensures release of the same code that was tested with the exception of the device driver. In a third embodiment, the tested code is the same as the release code, thereby enhancing quality control, quality assurance, verification, and/or validation procedures are maintained. In one embodiment of the invention, at least one state table is used in testing release code. In another embodiment, the test code is developed using a first platform and the release code is used on a second, distinct platform. In yet another embodiment, the invention relates to regression testing using simulated faults as monitored through log files.

### CROSS-REFERENCE TO RELATED APPLICATION

This application is a Continuation-in-part of U.S. patent application Ser. No. 10/472,856 filed Mar. 7, 2003 and claims benefit of U.S. provisional patent application Ser. No. 60/735,970 filed Nov. 9, 2005, both of which are incorporated herein in their entirety by this reference thereto.

### BACKGROUND OF THE INVENTION

1. Field of the Invention

The invention relates to a method and apparatus for performing state-table driven regression testing. More particularly, the invention relates to an application wherein a release build is used without the use of a debug build, which ensures release of the same code that was tested with the exception of the device driver.

2. Description of Related Art

In an embedded control system, debug code, also referred to as test code, is not identical to release code also known as product code as the debug code contains additional code used for debugging. The debugging code is removed in the release code. Thus, the debug code is not identical to the release code. The difference between the debug code and the test code results in a number of problems. For example, for complex code the release code and test code often does not function in an identical manner. The release code and debug code compile differently, execute differently, may execute different variables, and go down separate code paths. Further, having separate release and debug code often leads to hard-to-reproduce problems, such as an error existing in the release code that simply does not exist in the debug bode. Still further, historically it has been determined that there is a high probability of introduction of a new bug when new code is introduced to fix a previous error [Frederick P. Brooks, Mythical Man-Month, 1975/1995]. This risk increases as software complexity increases. Thus, during the course of development of a computer program many software faults or bugs are discovered and fixed necessitating regression testing to check for errors induced by the debugging process.

Software Verification

Several approaches for verifying software exist as summarized, infra.

Debugger

A significant portion of the software that makes up an embedded control system is dedicated to error handling. Because the code is intended to be executed only in the event of a failure of some sort, it is usually difficult to create the proper scenarios to exercise many of these error paths prior to release of the product. In addition, uniform testing coverage of error paths has been difficult to achieve.

The usual approach to testing hard to reach paths is to embed special debug code, marked off by statements such as, ‘#ifdef TEST . . . #endif’. However, this approach results in exhaustive testing on debug code where the debug is different than what is actually shipped as the release code.

J. Edwards, D. Evans, J. Mehl, J. Phelan, J. Wheatley, Method and apparatus for debugging applications on a personality neutral debugger, U.S. Pat. No. 6,011,920 (Jan. 4, 2000) describe a method and apparatus for debugging applications on a microkernel without invoking services provided by a particular personality. The instrumentation server sets an application into debug mode by either attaching to the application or by having the application launched by a given microkernel loader.

L. You, N. Rajgopal, M. Wimble, Debugging system with portable debug environment-independent client and non-portable platform specific server, U.S. Pat. No. 5,815,653 (Sep. 29, 1998) describe a system for debugging using a client debugger object and at least one non-portable server debugger object with platform-specific debugging logic. The server debugger object performs platform-specific debug operations on the software to be debugged. The platform-specific results generated by the debugging operations are translated to debug environment-independent results and returned to the client debugger object.

Assertion Testing

Another common testing technique is to use assertion testing, which does extra checking during debug builds versus release or production builds of the software. But, once again, this means the final released software is not exactly the same as that being testing. Thus, the release code and the test code does not function in an identical manner. As described, supra, the release code and debug code compile differently, execute differently, execute different variables, and go down separate code paths.

Synchronized Execution

M. Bauman, D. Bloom, J. Desubijan, and L. Byers, Method and apparatus for synchronizing independently executing test lists for design verification, U.S. Pat. No. 6,336,088 (Jan. 1, 2002) describe a method and apparatus for synchronizing the execution of two or more test lists at desired synchronization points. A test driver and controller are used to execute each test list and to monitor the execution of each test list.

Error Injection

I. Chirashnya, G. Machulsky, R. Ross, and L. Shalev, Error injection apparatus and method, U.S. Pat. No. 6,011,920 (Jan. 4, 2000) describe a method for simulation testing of a system via injecting an error through a node so as to simulate an error condition in the system. Operation of the system is subsequently followed so as to evaluate the system error condition.

S. Kaufer, T. Ramgopal, A. Sivakumar, Function simulation, U.S. Pat. No. 5,812,828 (Sep. 22, 1998) describe a computer implemented method of simulating a function including the step of using code to simulate check instructions for each function with the code.

J. Suwandi, M. Talluri, Method and apparatus for testing a computer system through software fault injection, U.S. Pat. No. 6,701,460 (Mar. 2, 2004) describe a system for testing a computer system by using software to inject faults into the computer system while the computer system is operating. This fault point causes a fault to occur if a trigger associated with the fault point is set and if an execution path of the program passes through the fault point. If the fault point is encountered while executing the executable code, the system executes the fault point by: looking up a trigger associated with the fault point, determining whether the trigger has been set, and executing code associated with the fault point if the trigger has been set.

D. Campbell, Uniformly distributed induction of exceptions for testing computer software, U.S. Pat. No. 6,513,133 (Jan. 28, 2003) describes a method, apparatus, software, and a data structure for more efficient fault testing of system software. A table is used to track routines that have been subjected to induced faults. The table is used to determine call paths not yet subjected to induced exceptions. These call paths are subsequently subjected to exceptions, thereby improving uniformity of distribution of induced exceptions.

J. Sanchez, P. Jeffrey, Automatic fault injection into a JAVA virtual machine (JVM), U.S. Pat. No. 6,477,666 (Nov. 5, 2002) describe a system and method for automatically injecting faults into a JAVA application to direct proper handling of various faults and exception under various conditions. An automatic fault injector is coupled to the Java Virtual Machine and the JAVA program is initiated to inject the faults at various times and places.

Fault Tolerance

R. Klemm, N. Singh, T. Tsai, Distributed indirect software instrumentation, U.S. Pat. No. 6,216,237 (Apr. 10, 2001) describe a software instrumentation tool operative to control execution of a target program and to execute user-specified instrumentation actions upon occurrence of corresponding user-specified events during target program execution. The tool is optionally used with fault tolerance.

T. Rice, G. Bennett, Toggling software characteristics in a fault tolerant and combinatorial software environment system, U.S. Pat. No. 6,634,019 (Oct. 14, 2003) describe a fault tolerant software environment, where various components, such as portions of computer applications, are objectized into entities represented by codons allowing improper syntax to occur for testing.

For the debugger, assertion testing, synchronized execution, error injection, and fault tolerance approaches described, supra, there are differences between the test code and release code. As described, supra, differences between test code and release code lead to a number of problems, including:
compilation differences between the test and release code;
initialization differences between the test and release code;
errors in the release code that do not exist in the test code;
execution differences between the test code and release code; and
difficulties in verifying and validating release code that has variances compared to the test code.

For example, in typical debug code, the variables are zeroed and in non-debug code the variables are not zeroed. This results in considerable difficulties in debugging and/or validating source code after debug code is removed. For instance, one or two variables are not initialized properly resulting in unforeseen errors in code execution.

None of the above listed citations teach the use of an embedded application program for testing embedded code, wherein the tested embedded code is both the source code and the source code is used without changes in the underlying code in corresponding test or release software. Further, none of the above listed citations combine testing embedded source code, such as application program testing, with use of state tables and/or log files for verifying and/or validating software. Still further, none of the above listed citations teach the use of generating source code on a first platform and using release code on a second platform, where the source code is substantially similar to the release code.

Clearly there exists in the art a need for easy debugging of release software during the design and development stage; for ease of maintenance of released code; and for verification, validation, quality control, and quality assurance of released code.

### SUMMARY OF THE INVENTION

The invention relates to a method and apparatus for performing regression testing using simulated faults. More particularly, the invention relates to an application wherein a release build is used without the use of a debug build, which ensures release of the same code that was tested with the exception of the device driver. Still more particularly, the invention relates to generation of release code tested in substantially the same manner as the source code or test code, where use of a source code for generation of both a standard log file and a comparison log file aids in confirming functionality of the source code on a target platform.

### BRIEF DESCRIPTION OF THE DRAWINGS

FIG. 1 provides a flow chart showing generation of log files and subsequent log file comparisons;

FIG. 2 provides a block diagram of the relationships of the components of regression testing using simulated faults; and

FIG. 3 provides a flow chart showing possible log files.

### DETAILED DESCRIPTION OF THE INVENTION

Overview

The invention comprises a method and apparatus for generation of release code tested in the same manner as the source or test code. Still more particularly, the invention relates to regression testing using simulated faults as monitored through log files. More particularly, the invention relates to an application program using at least one state table in testing release code. Still more particularly, the invention relates to using a release build without use of a debug build, which ensures release of the same code that was tested with the exception of the device driver. Preferably, regression testing uses simulated faults as monitored through log files to ensure that quality control methods, verification, and/or validation procedures are maintained. The invention is used, for automated regression testing to ensure that changes or additions to application program code do not adversely affect previously working code. In one embodiment, the tested code is the same as the release code. In a second embodiment, at least one state table is used in testing release code. In a third embodiment, the test code is developed using a first platform and the release code is used on a second, distinct platform.

Definitions

Personal Computer: Herein a personal computer is used to refer to a stand-alone computer workstation, a personal laptop computer, a terminal of a computer mainframe, a distributed computing device, or any other system where computer coding is performed that is not an end product where the end product is a stand alone device.

Stand-Alone Device: Herein a stand-alone device refers to a device sold on the marketplace to serve a function, wherein the stand-alone device is not a personal computer. A consumer device is a consumer device having embedded software, such as a medical device, a communication device, home appliance, aircraft, automobile, and the like.

Software: Intellectual creation comprising the programs, procedures, rules, and any associated documentation pertaining to the operation of a data processing system.

Validation: Confirmation by examination and provision of objective evidence that the particular requirements for a specific intended use can be consistently fulfilled. Validation activities ensure that the device, in its entirety, conforms to user requirements. These activities are performed on initial production units or their equivalents. Testing is done under actual or simulated use conditions.

Verification: Confirmation by examination and provision of objective evidence that specified requirements have been fulfilled. Verification activities, which involve tests, inspections and analyses, are performed during each phase of the verification and validation (V & V) process. Verification establishes the conformance of design features to requirements, and ensures that every requirement has been fulfilled by the design specification.

Overview of the Invention

Having separate debug code and release code removes confidence that the release code acts in the same manner as the debug code, as described supra. Having release code that is the same as debug code is found to alleviate this problem. To clarify the invention, where source code and release code are substantially similar and the terminology of debug code is misleading, the terminology of source code and test code is used. Source code is used to generate a standard log file, such as a gold log file. The terminology of test code is used for the tested system after changes are made to the source code or when the source code is used on a separate platform. Accordingly, the source code is used to generate a gold log file, and the test code is used in generation of a comparison log file, such as a test log file. When iterative debugging is performed on the source code after intermediate testing, the newly created code is again referred to as the source code. In the end, after code adding new functionality is implemented to the source code and debugging is complete, the source code is the same as the test code and/or the source code is the same as the release code.

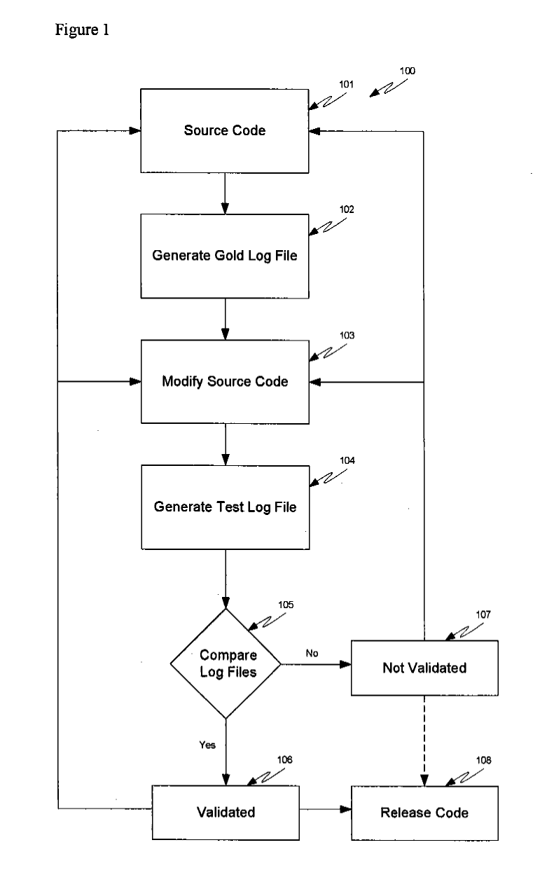

In one embodiment of the invention, a release build that is substantially the same as the source build is used, which ensures release of the same code that was tested with the exception of a device driver, time stamps, and date stamps. FIG. 1 shows a system for validating source code 100. Source code 101 is generated by a programmer and is used in combination with a state table driven test format, described infra, to generate a gold log file 102. The source code 101 is modified by adding functionality, removing functionality, to clarify the source code, and/or by debugging to yield modified source code, alternatively referred to herein as test code 103. The modified source code is subsequently used in combination with the same state table driven test format to yield a test log file 104. The gold log file and test log file are then compared 105. Preferably the gold and test log files are identical. Some deviations from identical files are acceptable, such as those due to time stamps, date stamps, and variations resulting from real world hardware input variation. Comparison of the gold and test log files is either validated 106 or not validated 107. Subsequently, the source code 101 is altered or the modified source code 103 is further modified. In either case, the process is iteratively repeated. At any point the validated source code 106, or less preferably the un-validated source code 107, is released as the release code 108.

In embodiments of the invention described herein, the source code or source build undergoes one or more iterative updates, such as to add functionality and/or to remove bugs. Herein, the source code tested after changes are made to the code is referred to as test code. Successive versions of the source code are referred to as test code, where the test code generates test log files, which are compared to previously generated gold log files generated using an earlier version of the source code. Each test tests output of the log file either to inform the programmer that the current modifications of the source code did not affect program results outside of the currently modified region or to inform the programmer that the current source code modifications affected program results outside of the currently modified region. Regression testing is the generation and comparison of the gold log file and the test log file, preferably using one or both of a state table driven test and a simulated hardware fault. Regression testing is performed using source code that does not have separate debug code beyond that which is necessary to run state table test or simulated hardware faults. Accordingly, there is no special debug build versus release build, thereby avoiding the separate codes and the above identified problems associated with having separate debug and release code. The final version of the source code is referred to as release code, where it is not necessary to remove specialized debug code from the source code. The release code is also referred to as production release code.

In another embodiment of the invention, regression tests are run after making one or more changes to the system to verify that a fix does not adversely affect previously properly running application code. Preferably, the regression tests are run automatically, such as after a nightly build of the current software. Preferably, all tests are re-run and the results reported to the developers, such as through an email, before the developers begin the next workday.

Cross-Platform

In still another embodiment of the invention, the source code is prepared on a first platform and the release code is implemented on a second platform also referred to as a target platform. The first platform and second platform use a different family of processors. For example, the source code is prepared on a first platform having a system using an Intel x86 processor, such as a Pentium processor. The release code is subsequently used on a second platform using a processor, such as on a Motorola or advanced RISC machine (ARM) processor, where the first platform and second platform are from different processor families. In the case which the first platform is a system that uses floating point software, such as an x86 processor, examples of a second platform include systems that use an x-scale processor, an Intel PXA255 processor, an advanced RISC machine (ARM) processor, or a Advanced Reduced Instruction Set Computer (RISC) Machine processor. In a first case, the release code is deployed on a stand alone platform separate from the platform used in developing the source code. In a second case, the release code is alternatively modified source code also referred to as test code. The modified source code is code under development where modifications include modification: to add functionality, to remove functionality, for clarifying, or for optimizing the source code, and/or for debugging. Developing source code on a first platform, such as an x86 processor and implementing the source code on a second platform is useful because:
the target platform often has limited functionality, such as limited:
   memory;
   data storage;
   visual display capabilities, such as small or no monitors;
   access to code and data; and
   limited software development tools;
development tools are better developed and are currently implemented on x86 processors; and
the x86 processors are typically faster than processors used on the target platform, such as a stand-alone consumer device.

Developing source code on a first platform, such as an x86 processor, and implementing the source code on a second platform is also useful due to the removal of the requirement of removing debug code for implementation on the target platform. As described, supra, the removal of debug code results in a number of problems such as the debug removed code:
compiling differently;
initializing differently, such as differences in variable initialization.
executing differently;
executing different variables; and/or
going down separate code paths.

For example, as described supra, in typical debug code the variables are zeroed and in non-debug code the variables are not zeroed. This results in considerable difficulties in debugging and/or validating source code after debug code is removed. For instance, one or two variables are not initialized properly, resulting in unforeseen errors in code execution.

In the embodiment where source code is developed on a first platform and developed on a second platform, the gold log files and test log files are developed and tested as described, supra, and detailed, infra. For example source code generated by a programmer on a first platform is used in combination with state table driven testing and/or with simulated hardware faults to generate a gold log file. The source code is subsequently implemented or modified and implemented on a second platform, such as a target platform or a stand-alone device. The state system generates a test log file using the target platform. The gold log file and test log file are then compared, typically using the first platform. The similarities and differences between the gold and test log files aid the programmer in debugging, verifying, and/or validating the modified source code. Subsequently, the source code iteratively further modified and/or released.

Herein, code required to support automatic regression testing is limited in size and complexity and is generally directed toward the saving or comparison of log files. Moreover, the special code needed for testing is always present in the source code in the system, as well as in the release code used in the production version. This is consistent with the source build being the same as the test and/or release code or release build, which guarantees that the code that was tested using the source code is the same code that is being deployed in the test code and/or release code.

In yet another embodiment of the invention, gold log files and test log files are generated using a state table with optional simulated hardware faults. The source code is tested using data provided within one or more state tables. The state table directs functions to test with the source code. Preferably, the state table or set of state tables cover a multitude of subroutines and/or paths in the source code. A given state table contains one or more parameters for testing a set of conditions.

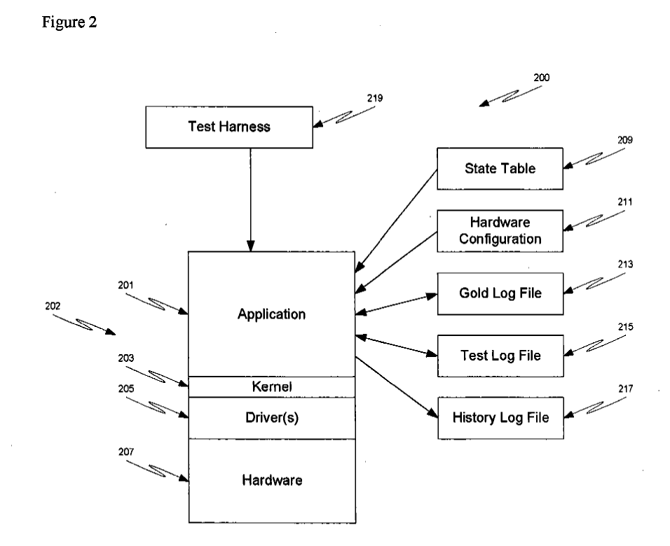

FIG. 2 is a block diagram showing the relationship of the components of a software development and/or release system 200 using regression testing using a state table and optional simulated hardware faults. The system 200 includes a software system 202 having an application 201, a kernel 203, and driver 205. The operating system includes the kernel 203 and a driver 205. The software system 202 interfaces with the hardware 207 or simulated hardware. As above, the application source code takes a set of test conditions and compares a test log file 215 with a previously generated gold log file 213, where the gold log file was created prior to source code modification or prior to the source code being implemented on a separate platform from where the source code was generated. Preferably, the test conditions are provided to the application 201 through at least one of a command line option, a state table 209, and a simulated hardware configuration 211. Initially, the application generates a log file from the source code having test conditions to create a gold log file. Subsequently, the source code is modified by adding functionality or by debugging the source code to yield test conditions which, when fed into the system, are used to generate a test log file 215 and/or a history log file 217. The test log file is compared with the gold log file. Preferably, the gold log file and test log file are not time-stamped. Preferably, at least a pass or fail indication is provided based upon the comparison of the gold file and the test log file. Optionally, the test log file is saved into a history log file for use with verification, validation, quality control, and/or quality assurance procedures. Preferably, the history log files are time stamped.

In one embodiment, a set of tests are provided in a test harness 219. Preferably, the application 201, kernel 203, driver 205, state table 209, simulated hardware configuration 211, gold log file 213, and test harness 219 are source code controlled. Optional components include at least the state table 109, hardware configuration 211, and gold log file 213. The elements of FIG. 2 are further described, infra.

Sub-Systems

Hardware/Software

The software 202 includes the application 201, kernel 203, and one or more drivers 205. The application or release code is preferably in an embedded device. The driver is part of the kernel space of the operating system, which is separate from the executable code that makes up the application being tested. The driver is called from the application code using input/output (I/O) calls, such as read, write, and input/output control. Examples of drivers include an input/output driver and a disk driver. The software 202 interfaces with the hardware 207. For example, where the application tells the kernel to turn on a lamp, the kernel tells the input/output driver, which interfaces with the hardware, to do so. Preferably, a Linux or equivalent system is used due to the ease of rebuilding an input/output driver under Linux, which allows dynamic unload and reload of an input/output driver. In another embodiment, a Windows-based or other operating system is used.

Because the test code used in regression testing inherently includes code for debugging, it is important that the simulated hardware driver is not accidentally enabled in the real device. Several steps are preferably taken to guard against simulated hardware being enabled in the deployed device. The application program queries the version of the driver, and if it finds the test driver displays a special icon on the screen indicative of an erroneous state, such as enabled simulation hardware. Similarly, a special icon is displayed if a test state table is loaded from the command line.

Testing

In another embodiment of the invention, a test harness is preferably used in performing regression testing using simulated conditions and/or faults. The test harness uses state-table driven regression testing as described herein. The test harness operates in a manner consistent with a batch file and is used to control which tests are run, the order of the run, and/or the timing of the run. An example of a test harness is a set of about ten, one hundred, or one thousand tests to be run. If a particular test fails, such as test number five, the test harness continues to run subsequent tests. Each test is controlled by a state table. Preferably a state table is paired with a hardware configuration file for a given test or has no configuration file if no simulated faults are being tested. For example, there are one hundred state tables for one hundred tests run in the test harness, or the state tables are combined into a single table or a plurality of tables.

A particular example of testing follows. First, a test, such as test number one, is run and a test log file is obtained and saved as a gold log file. Subsequently, test number one is rerun after code modification and another test log file is obtained. The test log file is compared to the gold log file. Preferably, the entries in the test log file and gold log file are not time stamped so that the log files can be compared for identical elements. If the elements are identical, the test passes; otherwise it fails. However, in the event of known differences, such as time and date stamps, between the gold file and the test log file, code not requiring the files to be identical is used to determine if the test passes. Preferably, the test log file is saved with a time stamp and the test result in a history log file associated with the particular test. Thus, the history log file provides documentation that a particular test was run at a particular time along with the test result. This is particularly useful for use with government regulated bodies, for all forms or quality control, and/or for validation Log files are further described, infra.

All of the hardware unique to the system, except the central processing unit and memory, is handled by one or more specific hardware drivers. Normally, a driver interfaces with the hardware reading and writing from/to hardware-specific registers on the microprocessor. These registers might control the status of I/O pins on the processor, or may just set up the parameters for a more complicated I/O operation to be initiated later. However, in regression testing one or more of the real drivers are replaced by a substitute driver. In the Linux operating system, as with any Unix-like operating system, hardware drivers are installed and uninstalled without having to reboot the system. These means the driver code can also be part of the nightly build, and re-installed as necessary before the automated regression testing that follows the build.

In addition to the I/O commands that are provided to simulate the real hardware, the test driver preferably has an additional input/output control command that allows for the downloading of a hardware configuration file, which can specify that certain simulated hardware has failed. For example, in a spectral analyzer the simulated hardware failures include a failed source or a failed detector array. This simulated fault injection feature allows testing of seldom taken error paths in the application code to be tested easily without having to make any changes whatsoever to the application source code.

The log files are optionally used to test on a Linux computer, a development board, and/or the final system itself. The log files are also useful for checking accuracy of floating point software, such as on an Advanced Reduced Instruction Set Computer (RISC) Machine processor or ARM™ (Cambridge, England) processor, or floating point hardware, such as on an x86 processor.

State Machine

The application program is preferably controlled via a software-driven state machine. The state machine is preferably used to control the individual regression tests. The state machine uses a state table. A state table optionally contains a single set of parameters for generating a test file, a gold log file, and/or a test log file. However, preferably a series of state tables are used, where each state table tests a given condition or a given set of conditions. Alternatively, a state table contains a plurality of parameters corresponding to a plurality of generated test files and/or test log files. The state table(s) preferably contain a set of tests that are developed to provide broad code coverage. Each test is run individually from a known set of initial conditions. As described, supra, preferably one failed test does not stop overall regression testing for a given test run.

A state table is preferably not part of the embedded code. Rather, the state table is preferably a loadable file, such as a text file. In another embodiment, the state table file is in human readable form. However, a compiled version is also usable with the invention. Preferably, there is no special application code needed to carry out the logic of the tests. Preferably, the entire source code application is controlled via a state machine, using plain text state tables that are externally loaded and compiled into a more compact binary format. The tests make use of special state tables, one for each test, also specified on the command line.

Using test state tables versus the regular state tables that drive the real application is analogous to a debug/no debug code situation, but at a higher and more manageable level. For example, there is preferably only one main state table versus dozens or hundreds of source files.

In addition, the name of any hardware configuration file, if needed for the test, is also provided on the command line. All of these parameters, e.g. the name of the test state table, the name of the test log file, the name of the optional hardware configuration file, and optionally the gold log file, are preferably saved in a time-stamped special history log file that documents that each of the tests has been performed and the corresponding result, such as pass or fail. The log file system is further described, infra.

Uses of a state table includes one or more of:
hardware testing;
testing code paths;
data gathering;
to process data; and
data output.

For example, with a control system for a spectrophotometric analyzer, such as a noninvasive analyzer or a noninvasive glucose concentration analyzer, optional tests include testing any of:
lamp state;
data collection parameters;
data collection;
spectral collection;
hardware configuration;
integration time setting;
motor position;
motor movement;
thermoelectric cooler setting;
algorithms used to process/analyze data;
output of data; and
display of data.

Additional detail of a noninvasive glucose analyzer, which is a system usable with this invention, has been previously disclosed in U.S. patent application Ser. No. 10/472,856 filed Mar. 7, 2003, which is incorporated herein in its entirety by this reference thereto.

Log File System

In one embodiment of the invention, a log file system is preferably used. Generally, a log file system allows recording and/or summarization of each action, such as those directed by elements of a state table. The use of a comparison between a test log file and a gold log file within the code allows a test without having to edit either the source code or the test file manually to include the tested value. The log file system is useful in verification and/or validation procedures, in documentation, and in regulated fields, such as those under Food and Drug Administration control, Federal Aviation Administration, United States Securities and Exchange Commission, or additional government or industry regulated fields.

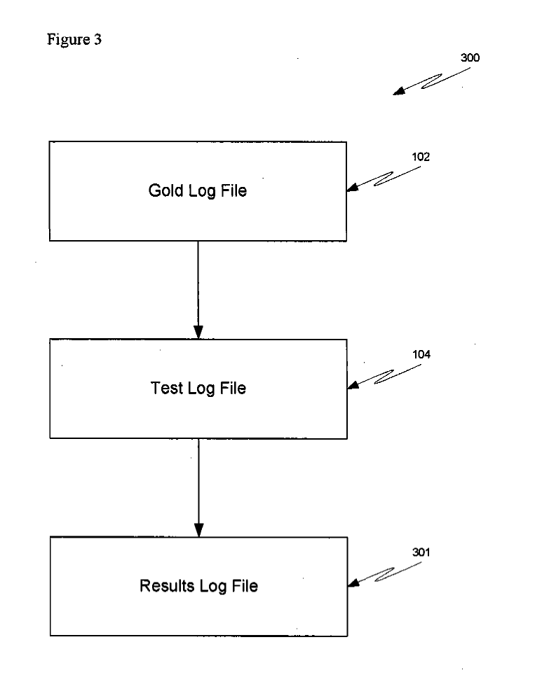

FIG. 3, a generalized log file system flowchart. A log file system 300 typically uses a gold log file 301, a test log file 303, and a results log file 305, which are further described infra.

A log file system 300 records results for at least a portion of performed tests. The overall results, such as pass, fail, a calculated result, a generated symbolic text, and/or of a test, are based on a comparison of the test log file 104 with the gold log file 102. In one instance, a gold log file is prepared the first time that a particular test or set of tests are run. Typically, a gold log file is prepared manually by a programmer when the code is determined to be in a state where a gold file is appropriate, but an automated procedure is optionally used. The state table or set of instructions is either tested manually to produce a gold log file or is tested in an automated procedure, such as the first time the test is run, to produce a gold log file. A file name is given or assigned to the results and the results are saved as a gold log file. Preferably, the gold log file is then copied into a source code repository or control where it is used in later comparisons against future test log files. Optionally, in an automatic regression test, the name of a gold log file previously saved off is used to call the gold log file in subsequent comparison testing.

In subsequent testing, the gold log file is compared or matched against a dynamic log file, such as a test log file, generated for a particular test, such as a test provided in a state table. In the preferred embodiment of the invention, the gold log file and test log file exactly match.

In a first case, the gold log files are placed under source code control, such as a concurrent versions system (CVS), so that if changes in the test script are later performed, the particular test run may be later retrieved. This is particularly important in development of code for use in the field of a government regulated body and/or as part of a results or history log file 301.

In a second case, simulated hardware or results are run using a test file to generate a test log file, which is compared against the gold standard log file. As a first example, hardware, such as lamp current is tested. As a second example, a result such as a calculated value, is tested. In the case of simulated hardware, exactly the same result is expected, thus simplifying comparison testing. Optionally, code is prepared that accepts a range of values to allow for hardware variations when not using simulated hardware. In one instance, the simulated hardware is used to test the source code directly by simulating the hardware fault during operation of the source code. Optionally, the simulated hardware is tested through use of the simulation data being incorporated into one or more state tables, where the state table directs functions to test within the source code and/or where the state table covers a multitude of subroutines and/or paths in the source code.

In a third case, log files are generated without timestamps and/or date stamps. This allows the gold log file to match a test log file run at a separate time. However, preferably a timestamp for each test file or gold file resulting in a test log file or gold log file, respectively, are saved in an overall history log file, along with other parameters for the test file that were furnished on the command line, thereby yielding permanent tracking data that a particular test was performed.

In a fourth case, one or more test log files are generated using one or more corresponding state tables. Preferably, each action of a state table is logged along with displayed values and/or other test results. Preferably, no timestamps are recorded using this system so that an initial log file, such as a first run of a test, can be saved as the gold log file, wherein the gold log file is later used as a comparison with a subsequent test log file. As described, supra, time-stamped versions of the gold log file and/or test log file are preferably saved into a history log file.

In a fifth case, a test log file is made into a new gold log file.

Verification and Validation

An important goal of verification and validation (V & V) is the ability to establish objective evidence that all product requirements are properly implemented with full traceability and compliance with regulatory requirements. Verification and validation is performed via a structured methodology that applies design controls to both software and hardware. A structured approach with design controls ensures that all applicable design considerations are addressed and increases the likelihood that the resulting design translates into a device that is appropriate for its intended use.

Invention's relevance to V & V

Hardware and software testing is facilitated with the above described method and apparatus for performing state-driven regression testing using simulated faults.

Verification and validation requires that a variety of tests be performed. Software unit testing is conducted to exercise and verify the program logic, including such items as the control structures, the boundary conditions, computations, comparisons, and control flow. When unit testing is completed, integration testing is performed to ensure that the individual software and hardware modules work together and the desired functionality exists. When necessary, appropriate corrections are made to the source code following both unit and integration testing.

Subsequent to integration testing, installation qualification is performed for the transition from the development environment to the test environment. Installation qualification is designed to ensure that hardware and software are installed according to the installation design of the software developer and hardware designer. This provides documented proof that the installation is done according to the developers' and designers' specifications. Subsequent to installation qualification, operational/performance qualification testing is performed. Operational/performance qualification ensures system operation as defined in the one or more requirements documents. Preferably, operational/performance qualification challenges the system to fail to ensure the system does not perform in unintended ways. Operational/performance qualification tests are generally performed as clinical trials with prototype devices. When necessary, appropriate corrections are made to the source code following operation/performance qualification testing.

The invention provides performance of appropriate regression testing after changes to the source code to assure that none of the previously existing required functionality has been disturbed. The inventive methodology facilitates regression testing by providing a battery of tests that are consistently executed in an organized and auditable fashion. Moreover, it provides an audit trail of testing via gold, test, result, and/or history log files or reports.

The above described invention finds application in complex code, such as in flight control systems or medical devices.

Permutations and combinations of the above described elements, methods, state tables, simulated hardware testing, log files, methods, apparatus and obvious variants of the above described methods and apparatus are also included as part of this invention.

Those skilled in the art will recognize that the present invention may be manifested in a variety of forms other than the specific embodiments described and contemplated herein. Departures in form and detail may be made without departing from the spirit and scope of the present invention. Accordingly, the invention should only be limited by the Claims included below.

1. A computer implemented method for testing cross-platform functionality of source code, comprising:
wherein use of said source code for generation of both said gold log file and said test log file substantially confirms functionality of said source code on said target system.

2. The method of claim 1, further comprising the steps of:
providing state table driven embedded source code operational on a host system;
loading a state table from a computer readable storage medium;
generating a gold log file by applying said state table to said source code, wherein said state table directs functions to test within said source code, wherein said state table covers a multitude of subroutines and paths of said source code;
performing automated regression testing on a target system using said source code and said state table to yield a test log file, wherein said source code tested on said host system and on said target system comprises no enabled debug flags;
comparing said test log file to said gold log file, wherein said host system differs from said target system.

3. The method of claim 2, further comprising the step of editing said source code, wherein said step of editing occurs after generation of said gold file and prior to said step of regression testing.

4. The method of claim 3, wherein said step of editing comprises: editing a first subroutine, wherein said step of comparing comprises: testing a multitude of subroutines.

5. The method of claim 2, further comprising the step of:
simulating a hardware fault during operation of said code, wherein said step of simulating occurs in both the case of generating said gold log file and in the case of performing automated regression testing to yield said test log file.

6. The method of claim 2, further comprising the step of:
testing coverage of said source code using a hardware simulator to test a plurality of hardware states, wherein said host system comprises a software driver interfaced directly with said hardware simulator.

7. The method of claim 2, wherein said source code comprises identical code on said host system and said target system.

8. The method of claim 2, wherein said source code is tested in release mode on said target system.

9. The method of claim 2, wherein said target system comprises any of:
a glucose concentration analyzer;
a biomedical device;
Food and Drug Administration (FDA) regulated software; and
Federal Aviation Administration (FAA) regulated software.

10. The method of claim 2, wherein said state table comprises:
a set of parameters for testing a set of conditions.

11. The method of claim 2, wherein said source code comprises software application code.

12. The method of claim 2, wherein said source code builds a software application code.

13. The method of claim 2, wherein a build of said source code generates cross-platform code operational on said target system, wherein said cross-platform code is not operable on said host system.

14. The method of claim 13, wherein said build comprises a cross-platform build.

15. The method of claim 2, further comprising the step of:
altering said source code after generation of said gold log file.

16. The method of claim 15, wherein said step of altering comprises any of:
debugging said software application code; and
adding functionality to said software application code.

17. The method of claim 2, further comprising the steps of:
after running cross-platform; debugging; finding an error; debugging; and running cross-platform again; releasing the resulting edited software application code as a release build.

18. The method of claim 2, further comprising the step of using said gold log file and said test log file for any of:
quality control;
quality assurance;
a verification procedure; and
a validation procedure.

19. A computer implemented method for testing cross-platform functionality of source code, comprising:
providing state table driven source code operational on a host system;
loading a state table from a computer readable storage medium, wherein said state table directs functions to test within said source code, wherein said state table covers a multitude of subroutines and paths of said source code;
simulating hardware conditions via a hardware simulator to said host system, wherein said host system comprises a software driver interfaced directly with said hardware simulator;
generating a gold log file through testing of a combination of said state table and said hardware conditions to said source code;
performing automated regression testing on a target system using said source code and said hardware simulator and said state table to yield a test log file;
comparing said test log file to said gold log file, wherein said step of comparing substantially confirms functionality of said source code on said target system.

20. The method of claim 19, wherein said release mode comprises software with no debugging mode.

21. The method of claim 19, wherein said host system comprises a first computer platform using a first family of central processing units.

22. The method of claim 19, wherein said source code comprises both release code and debug code.

23. The method of claim 19, further comprising the step of:
if said test log file is substantially similar to said gold log file, implementing said edited software code on a target system.

24. The method of claim 19, wherein said hardware condition comprises at least three of:
lamp state;.
configuration of hardware;
data collection parameters;
motor movement;
temperature; and
spectral data collection.

25. The method of claim 19, wherein said source code is embedded.

26. The method of claim 19, wherein said state table comprises a series of tables.

27. The method of claim 19, wherein said state table comprises a plurality of test parameters.

28. The method of claim 19, wherein a release build does not necessitate a debug build.

29. An apparatus having hardware and software for testing embedded source code, comprising:
a target system having a first central processing unit, wherein said target system contains object code derived from said source code, wherein said source code is generated using a host system having a second central processing unit, wherein said first central processing unit and said second central processing unit are from separate families of central processors, wherein said target system comprises:
a stand alone device;
a state table;
a hardware configuration parameter; and
a gold log file generated on said host system, wherein said embedded source code generated on said host system operates within said target system,
wherein said gold log was generated by applying said state table to said source code on said host system, wherein said state table directs functions to test within said source code, wherein said state table covers a multitude of subroutines and paths of said source code;
wherein said target system uses automated regression testing, said state table, and said hardware configuration parameter to generate a test log file, wherein both said source code and said object code contain no enabled debug flags; and
wherein a comparison of said log file with said gold file validates said source and object code.

30. The apparatus of claim 29, wherein said first central processing unit comprises a floating point processor.

31. The apparatus of claim 30, wherein said second central processing unit comprises any of:
an x-scale processor;
an Intel PXA255 processor;
an Intel 8051 processor; and
an advanced RISC machine.

32. The apparatus of claim 30, wherein said target platform comprises a device having computer memory and input/output connectors.

33. A method for testing cross-platform functionality of source code, comprising:
providing state table driven embedded source code generated on a host system;
loading a state table from a computer readable storage medium;
generating a gold log file by applying said state table to said source code, wherein said state table directs functions to test within said source code, wherein said state table covers a multitude of subroutines and paths of said source code;
performing automated regression testing on a target system using said source code and said state table to yield a test log file, wherein said host system uses a first computer processor from a first family and said target system uses a second computer processor from a second family;
comparing said test log file to said gold log file.

34. The apparatus of claim 33, wherein said first computer processor comprises an x86 processor and said second computer processor comprises a processor that is not an x86 processor.
